(19) United States
(12) Patent Application Publication
(10) Pub. No.: US 2026/0010396 A1
(43) Pub. Date: Jan. 8, 2026

(54) METHOD AND DEVICE FOR LOCATING PROCESS EXECUTION EXCEPTION, APPARATUS, MEDIUM, AND PRODUCT

(71) Applicant: Glenfly Tech Co., Ltd., Shanghai (CN)

(72) Inventors: Ying WANG, Shanghai (CN); Fengxia WU, Shanghai (CN)

(21) Appl. No.: 19/186,172

(22) Filed: Apr. 22, 2025

(30) Foreign Application Priority Data
Jul. 2, 2024 (CN) 202410883411.3

(51) Int. Cl. G06F 9/48

(52) U.S. Cl. CPC G06F 9/4881

(57) ABSTRACT

A method for locating a process execution exception includes: inputting task data of a present upper-level task into a process verification model to obtain a task reference feature value and comparing it with an execution feature value corresponding to the present upper-level task, and recording the upper-level task number corresponding to the present upper-level task when the task reference feature value is inconsistent with the execution feature value; when the lower-level task corresponding to the upper-level task is not a bottom-level task, taking the lower-level task as a new upper-level task, and repeating the step of simulation; and selecting, when the lower-level task corresponding to the upper-level task is the bottom-level task, the bottom-level task that needs to be simulated according to the upper-level task number and inputting the task data of the bottom-level task into the process verification model to locate exception execution issues.

### CROSS-REFERENCE TO RELATED APPLICATIONS

The present application claims priority to Chinese patent application No. 2024108834113, filed on Jul. 2, 2024, the entire content of which is incorporated herein by reference.

### TECHNICAL FIELD

The present disclosure relates to the technical field of application data processing, and more particularly, to a method and device for locating process execution exception, a computer apparatus, a storage medium, and a computer program product.

### BACKGROUND

With the development of Graphics Processing Unit (GPU) technology, the application fields of GPU are getting more and more widely, including gaming business, display field, and artificial intelligence computing field, etc. To fully utilize the powerful display and computing capabilities of the GPU, multiple tasks are generally deployed into a single GPU for execution within the same time period. To avoid interference between these tasks, each task is assigned a unique process number, and each process number corresponds to an exclusive storage space.

For GPU, a standalone process can be a complex game application or a simple desktop operation, so the number of commands of each process is uncontrollable, and most of the time there can be tens of thousands of hardware commands.

In the event that the final drawing/calculation result of one of the processes differs from the actual result, due to the complexity and variability of the actual application, it is not possible for the existing technology to quickly locate the command segment that caused the issue from the tens of thousands of hardware commands.

### SUMMARY

In a first aspect, the present disclosure provides a method for locating a process execution exception, the method is applied to an electronic device and configured to locate exception execution issues in a target process running on the electronic device, the electronic device includes a command stream parser. The target process includes a plurality of tasks, the plurality of tasks are divided into a plurality of levels, and each upper-level task includes at least one lower-level task. The method includes:
obtaining, by the command stream parser, task data of the plurality of tasks of the target process, and inputting the task data of a present upper-level task into a process verification model to simulate an execution to obtain a task reference feature value, the process verification model is configured to calculate a correct execution result of the process;
comparing the task reference feature value with an execution feature value corresponding to the present upper-level task in the target process, and recording an upper-level task number corresponding to the present upper-level task when the task reference feature value is inconsistent with the execution feature value;
selecting, on a condition that the lower-level task corresponding to the upper-level task is not a bottom-level task, the lower-level task that needs to be simulated according to the task number of the upper-level task, and taking the lower-level task as a new upper-level task, and repeating the step of simulation; wherein the bottom-level task is not the lower-level task; and
selecting, on a condition that the lower-level task corresponding to the upper-level task is the bottom-level task, the bottom-level task that needs to be simulated according to the task number of the upper-level task, and inputting the task data of the bottom-level task into the process verification model to locate exception execution issues in the target process.

In some embodiments, the task includes at least one command, and the task data includes command data. Obtaining the task data of the task, and inputting the task data of the present upper-level task into the process verification model to simulate the execution to obtain the task reference feature value includes:
obtaining command data of multiple commands;
for each of the command data, on a condition that the command data matches the present upper-level task, inputting the command data into the process verification model to simulate the execution to obtain the command feature value of the command data;
accumulating the command feature value continuously on a condition that the present command data does not indicate an end of an execution of the upper-level task; and
accumulating the command feature value to obtain the task reference feature value on a condition that the present command data indicates the end of the execution of the upper-level task.

In some embodiments, after accumulating the command feature value to obtain the task reference feature value, the method further includes: resetting the accumulated task feature value to zero.

In some embodiments, inputting the command data into the process verification model to simulate the execution to obtain the command feature value of the command data includes:
inputting the command data into the process verification model to obtain the data feature of the command data;
selecting a feature value calculation method based on the data feature; and
calculating the command feature value of the command data by the selected feature value calculation method.

In some embodiments, accumulating the command feature value includes:
determining an accumulative calculation method according to the feature value calculation method; and
accumulating the command feature value by the accumulative calculation method.

In some embodiments, after inputting the task data of the present upper-level task into the process verification model to simulate the execution to obtain the task reference feature value, the method includes:
obtaining the task type of the present upper-level task;
obtaining a historical cumulative data corresponding to the present upper-level task according to the task type, and calculating a present cumulative data based on the historical cumulative data; and
calculating a storage address information based on the present cumulative data, and storing the present cumulative data based on the storage address information.

In a second aspect, the present disclosure provides a device for locating process execution exception, the device is configured to locate exception execution issues in a target process, the target process includes a plurality of task, the plurality of tasks are divided into a plurality of levels, each upper-level task including at least one lower-level task. The device includes:
a data obtaining module configured to obtain task data of the plurality of tasks, and input the task data of a present upper-level task into a process verification model to simulate an execution to obtain a task reference feature value, the process verification model is configured to calculate a correct execution result of the target process;
a feature comparison module configured to compare the task reference feature value with an execution feature value corresponding to the present upper-level task in the target process, and record an upper-level task number corresponding to the present upper-level task when the task reference feature value is inconsistent with the execution feature value;
a task loop module configured to select, when the lower-level task corresponding to the upper-level task is not the bottom-level task, the lower-level task that needs to be simulated according to the task number of the upper-level task, take the lower-level task as a new upper-level task, and repeat the step of simulation; where the bottom-level task is not the lower-level task; and
a problem location module configured to select, on a condition that the lower-level task corresponding to the upper-level task is the bottom-level task, the bottom-level task that needs to be simulated according to the task number of the upper-level task, and input the task data of the bottom-level task into the process verification model to locate exception execution issues in the target process.

In a third aspect, the present disclosure provides a computer apparatus, the computer apparatus includes a processor, and a memory having a computer program stored therein. When the computer program is executed by the processor, the processor is caused to realize the following steps:
obtaining task data of the plurality of tasks, and inputting the task data of a present upper-level task into a process verification model to simulate an execution to obtain a task reference feature value, wherein the process verification model is configured to calculate a correct execution result of the target process;
comparing the task reference feature value with an execution feature value corresponding to the present upper-level task in the target process, and recording an upper-level task number corresponding to the present upper-level task when the task reference feature value is inconsistent with the execution feature value;
selecting, on a condition that the lower-level task corresponding to the upper-level task is not a bottom-level task, the lower-level task that needs to be simulated according to the task number of the upper-level task, and taking the lower-level task as a new upper-level task, and repeating the step of simulation; wherein the bottom-level task is not the lower-level task; and
selecting, on a condition that the lower-level task corresponding to the upper-level task is the bottom-level task, the bottom-level task that needs to be simulated according to the task number of the upper-level task, and inputting the task data of the bottom-level task into the process verification model to locate exception execution issues in the target process.

In a fourth aspect, the present disclosure provides a computer-readable storage medium, the computer-readable storage medium has computer program stored therein, the computer program realizes the following steps when it is executed by the processor:
obtaining task data of the plurality of tasks, and inputting the task data of a present upper-level task into a process verification model to simulate an execution to obtain a task reference feature value, wherein the process verification model is configured to calculate a correct execution result of the target process;
comparing the task reference feature value with an execution feature value corresponding to the present upper-level task in the target process, and recording an upper-level task number corresponding to the present upper-level task when the task reference feature value is inconsistent with the execution feature value;
selecting, on a condition that the lower-level task corresponding to the upper-level task is not a bottom-level task, the lower-level task that needs to be simulated according to the task number of the upper-level task, and taking the lower-level task as a new upper-level task, and repeating the step of simulation; wherein the bottom-level task is not the lower-level task; and
selecting, on a condition that the lower-level task corresponding to the upper-level task is the bottom-level task, the bottom-level task that needs to be simulated according to the task number of the upper-level task, and inputting the task data of the bottom-level task into the process verification model to locate exception execution issues in the target process.

In a fifth aspect, the present disclosure provides a computer program product, the computer program product includes computer program, the computer program realizes the following steps when it is executed by the processor:
obtaining task data of the plurality of tasks, and inputting the task data of a present upper-level task into a process verification model to simulate an execution to obtain a task reference feature value, wherein the process verification model is configured to calculate a correct execution result of the target process;
comparing the task reference feature value with an execution feature value corresponding to the present upper-level task in the target process, and recording an upper-level task number corresponding to the present upper-level task when the task reference feature value is inconsistent with the execution feature value;
selecting, on a condition that the lower-level task corresponding to the upper-level task is not a bottom-level task, the lower-level task that needs to be simulated according to the task number of the upper-level task, and taking the lower-level task as a new upper-level task, and repeating the step of simulation; wherein the bottom-level task is not the lower-level task; and
selecting, on a condition that the lower-level task corresponding to the upper-level task is the bottom-level task, the bottom-level task that needs to be simulated according to the task number of the upper-level task, and inputting the task data of the bottom-level task into the process verification model to locate exception execution issues in the target process.

The method and device for locating process execution exception, the computer apparatus, the storage medium, and computer program product provided in the present disclosure are configured to locate exception execution issues in a target process, the target process includes a plurality of tasks, the tasks are divided into multiple levels, with an upper-level task including at least one lower-level task. The task data of the tasks are obtained, and the task data of the present upper-level task are input into the process verification model to simulate the execution to obtain the task reference feature value. The process verification model is configured to calculate the correct execution result of the process. The task reference feature value is compared with the execution feature value corresponding to the present upper-level task in the target process, and the upper-level task number corresponding to the present upper-level task is recorded when the task reference feature value is inconsistent with the execution feature value. When the lower-level task corresponding to the upper-level task is not the bottom-level task, the lower-level task that needs to be simulated is selected according to the upper-level task sequence number, therefore, it is sufficient to only simulate the execution of the lower-level tasks corresponding to the abnormal upper-level tasks. Then, the lower-level task is taken as a new upper-level task, the steps of simulation is repeated, and the above steps are repeated until the lower-level task corresponding to the upper-level task is the bottom-level task. The bottom-level task that needs to be simulated is selected according to the upper-level task number, and the task data of the bottom-level task is input into the process verification model to locate exception execution issues in the target process. Thereby, the number of tasks that need to be attended to during the execution of the simulation is reduced, and it is no longer necessary to simulate all of the tasks in the target process, which can improve the efficiency of locating the location of anomalies in the target process.

### BRIEF DESCRIPTION OF THE DRAWINGS

In order to describe the technical solutions of the embodiments of the present disclosure or the conventional art more clearly, the accompanying drawings required for describing the embodiments or for describing the conventional art will be briefly introduced as follows. Apparently, the accompanying drawings, in the following description, illustrate merely some embodiments of the present disclosure, for a person of ordinary skill in the art, other drawings can also be obtained according to these accompanying drawings without making any creative efforts.

FIG. 1 is a diagram of an application environment of a method for locating a process execution exception in an embodiment.

FIG. 2 is a flow diagram illustrating a method for locating a process execution exception in an embodiment.

FIG. 3 is a diagram illustrating the hierarchy of tasks in an embodiment.

FIG. 4 is a flow diagram illustrating step S202 of the method for locating a process execution exception in an embodiment.

FIG. 5 is a flow diagram illustrating step S304 of the method for locating a process execution exception in an embodiment.

FIG. 6 is a structural block diagram illustrating a device for locating a process execution exception in an embodiment.

FIG. 7 is a diagram of an internal structure of a computer device in an embodiment.

FIG. 8 is a diagram of the internal structure of a computer device in another embodiment.

### DETAILED DESCRIPTION OF THE EMBODIMENTS

In order to make purposes, technical solutions and effects of the present disclosure clearer and more explicit, the present disclosure is described in further detail below with reference to the embodiments in accompanying with the appending drawings. It should be understood that the specific embodiments described herein are merely for explaining the present disclosure, but not intended to limit the present disclosure. Without further description, elements, structures and features in one embodiment may also be beneficially incorporated into other embodiments.

In the description of the embodiments of the present disclosure, the term “and/or” in the description is only a way to describe an association relationship between associated objects, which means that there can be three relationships. For example, A and/or B can represent the following three cases: the presence of A alone, the simultaneous presence of A and B, and the presence of B alone. In addition, the character “/” in the description generally indicates that the context object is an “or” relationship.

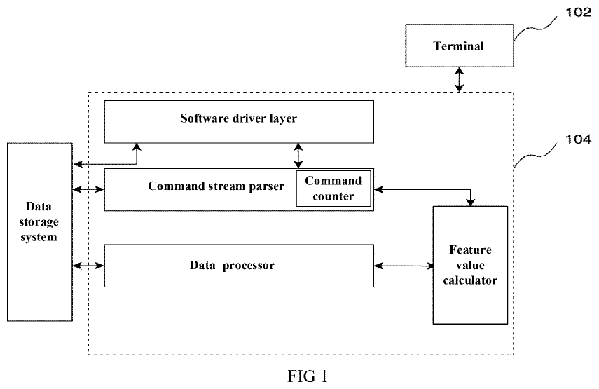

The present disclosure provides a method for locating process execution exception, which can be applied in an application environment as shown in FIG. 1. In the application environment, a terminal 102 communicates with a server 104 via a network, and the terminal 102 can be applied to display information analyzed by the server 104. A data storage system can store data that the server 104 needs to process. The data storage system can be integrated on the server 104 or can be placed on a cloud or other network server. The data storage system can be configured to store data such as task data, and command data. The terminal 102 can be, but is not limited to, a variety of personal computers, laptops, smartphones, tablets, IoT devices, and portable wearable devices. The server 104 can be implemented with a stand-alone server or a cluster of servers consisting of multiple servers. Exemplarily, the server 104 can include functional modules, such as a software driver layer, a command stream parser, a data processor, and a feature value calculator.

The software driver layer is configured to issue tasks and commands. The command stream parser is configured to parse all tasks and commands issued by the software driver layer, so that it can know precisely when to reset the feature values to zero, as well as when to generate, read, store, and record the features values, and can correctly record the current task number and other identifiers. The feature value calculator is configured to calculate corresponding feature values based on input data and features thereof. The command stream parser can also include a command counter for calculating a current cumulative number of commands.

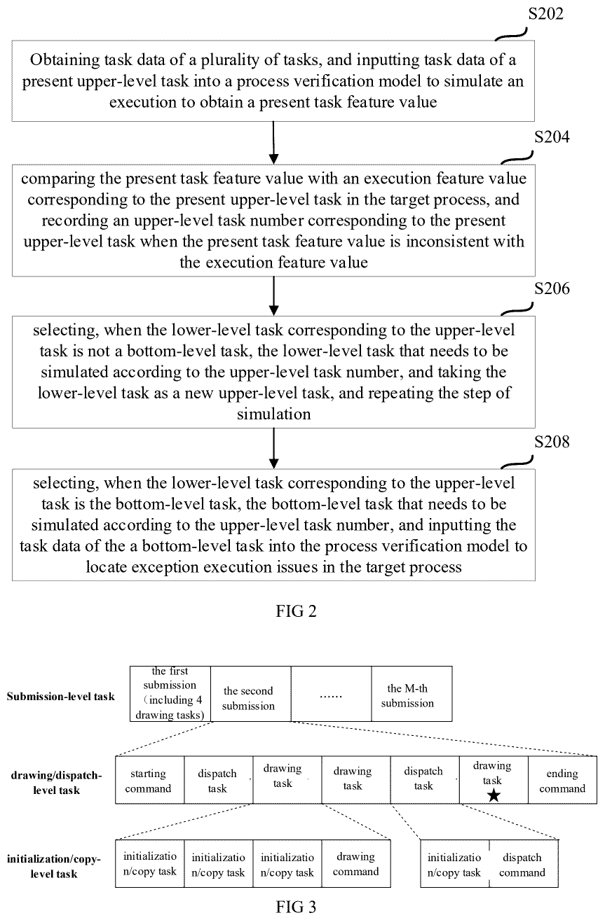

In an exemplary embodiment, as shown in FIG. 2, the present disclosure provides a method for locating a process execution exception, and an example where the method is applied to the server 104 in FIG. 1 will be described. The method is configured to locate the execution issues of a target process. The target process includes a plurality of tasks, and the plurality of tasks are divided into a plurality of levels. Each upper-level task includes at least one lower-level task. The method includes the following steps S202 to S208.

In step S202, task data of the plurality of tasks of the target process is obtained, and task data of a present upper-level task is input into a process verification model to simulate an execution to obtain a task reference feature value.

In some embodiments, the target process is the process whose execution result is abnormal.

The process verification model is configured to calculate a correct execution result of the process, and the process verification model is a software verification model. The task feature value is configured to represent the execution of the present task and the results of the present task execution.

Exemplarily, in a multi-process application scenario, each process corresponds to a process number, and the server 104 can determine a data storage space of a target process that matches the process number, so that the hardware executing the process as well as the software verification model can extract and record the feature value for the same process to obtain the corresponding task data. It should be noted that the application scenarios presented in this embodiment can be multi-process systems. The method can also be used to issue location in single-process systems, but in single-process systems there is no need to additionally specify specific process numbers.

Exemplarily, a series of write data is generated after each task in a target process is generated, and the server 104 can calculate the task reference feature value using a specific algorithm by simulating the execution of the process in the process verification model. Further, the bit width of the task feature value can be 64 bits, 128 bits, 256 bits, or the like, which is not limited in this embodiment.

In step S204, the task reference feature value is compared with an execution feature value corresponding to the present upper-level task in the target process, and an upper-level task number corresponding to the present upper-level task is recorded when the task reference feature value is inconsistent with the execution feature value.

Exemplarily, each task in the target process corresponds to a take number, take a target process that includes three levels of tasks as an example, the first level is a submission-level task, which has the coarsest granularity, and the task feature value for the present task at this level is generated after all the submitted tasks have been executed. The second level is a “draw/general computing”-level task, which has a moderate granularity, and the task feature value of the present task at this level is generated after each execution of the drawing/general computing task. The third level is a resource initialization/copy-level task, which has the finest granularity, and the task feature value of the present task at this level is generated after each execution of the resource initialization or copy task.

As shown in FIG. 3, the upper-level task and the lower-level tasks are relative concepts. Exemplarily, for the submission-level task, the “draw/general computing”-level task, and the resource initialization/copy-level task, when a submission-level task serves as an upper-level task, its corresponding lower-level task is a “draw/general computing”-level task, that is, a submission-level task includes at least one “draw/general computing”-level task. Similarly, when a “draw/general computing”-level task serves as an upper-level task, its corresponding lower-level task is a resource initialization/copy-level task, that is, a “draw/general computing”-level task includes at least one resource initialization/copy-level task.

In step S206, on a condition that the lower-level task corresponding to the upper-level task is not the bottom-level task, the lower-level task that needs to be simulated is selected according to the task number of the upper-level task, the lower-level task is taken as a new upper-level task, the steps of simulation is repeated.

The bottom-level task is not the lower-level task. The resource initialization/copy-level task does not include other types of tasks and is not an upper-level task, therefore, in this embodiment, the resource initialization/copy-level task is a bottom-level task.

Exemplarily, based on the hierarchical task structure described above, the server 104 can incrementally locate the location of the problematic process layer by layer when the number of tasks is relatively large.

Firstly, the server 104 can simulate execution based on the task data, the feature value calculator calculates the task feature value of the present task at the submission-level, and the command stream parser compares the calculated task feature value with the execution feature value of the present task executed by the hardware to be located, i.e., the actual executed feature value is compared with the correct feature value simulated by the software. When the comparison result is inconsistent, it is determined that the present submission-level task is abnormal, and the command stream parser records the task number corresponding to the present submission-level task.

Subsequently, the server 104 selects the “draw/general computing”-level task to be simulated for execution based on the task number of the submission-level task, and simulates the execution based on the task data. The feature value calculator calculates the task feature value of the present “draw/general computing”-level task. The command stream parser compares the calculated task feature value with the execution feature value of the present task executed by the hardware to be located, i.e., the actual executed feature value is compared with the correct feature value simulated by the software. When the comparison result is inconsistent, it is determined that the present “draw/general computing”-level task is abnormal, and the command stream parser records the task number corresponding to the present “draw/general computing”-level task.

In step S208, on a condition that the lower-level task corresponding to the upper-level task is the bottom-level task, the bottom-level task that needs to be simulated is selected according to the task number of the upper-level task, and task data of the bottom-level task is input into the process verification model to locate the execution exception of the target process.

The server 104 can select a resource initialization/copy-level task that requires simulated execution based on the task number of the “draw/general computing”-level task, and simulates the execution based on the task data. The feature value calculator calculates the task reference feature value of the present resource initialization/copy-level task, and the command stream parser compares the calculated task reference feature value with the execution feature value of the present task executed by the hardware to be located, i.e., the actual executed feature value is compared with the correct feature value simulated by the software. When the comparison result is inconsistent, it is determined that the present resource initialization/copy-level task is abnormal, and thus the location of the execution exception of the target process is located.

Further, if the task load is not too heavy, the server 104 can also expand the range of task data that needs to be subjected to simulated execution, increasing the task number that needs to be verified correspondingly.

The method for locating process execution exception provided in the present disclosure is configured to locate the execution issues of the target process. The target process includes a plurality of tasks, and the plurality of tasks are divided into a plurality of levels. Each upper-level task includes at least one lower-level task. By obtaining task data of the task, and inputting the task data of the present upper-level task into the process verification model to simulate the execution, the task reference feature value is obtained, and the process verification model is configured to calculate the correct execution result of the process. Then, the task reference feature value is compared with the execution feature value corresponding to the present upper-level task in the target process. On a condition that the task reference feature value is inconsistent with the execution feature value, the upper-level task number corresponding to the present upper-level task is recorded and a lower-level task that needs to be simulated execution is selected according to the upper-level task number. Therefore, only the lower-level task corresponding to the abnormal upper-level task needs to be simulated, and then the lower-level task is taken as the new upper-level task, the step of simulation is repeated, and the above steps are repeated continuously until the lower-level task corresponding to the upper-level task is the bottom-level task. The bottom-level task that needs to be simulated is selected according to the upper-level task number, and the task data of the bottom-level task is input into the process verification model to locate execution exception of the target process. Therefore, the number of tasks that need to be attended to during the execution of the simulation is reduced, and it is no longer necessary to simulate all of the tasks in the target process, which can improve the efficiency of locating the anomalies in the target process.

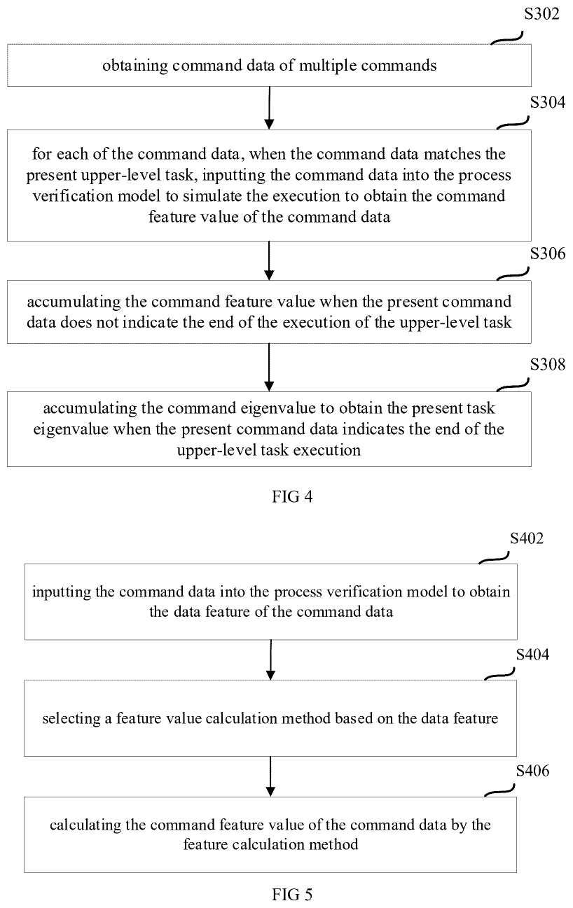

In an exemplary embodiment, as shown in FIG. 4, the task includes at least one command, the task data includes command data, and step S202 includes step S302 to step S308.

In step S302, command data of a plurality of commands is obtained.

Exemplarily, types of commands may include drawing commands, general computing commands, resource initialization/copy commands, and the like. The drawing command is the most important command in the graphics drawing pipeline, such as D3D, vulkan, etc., each of which defines a drawing interface to perform corresponding drawing. The software driver layer translates these drawing interfaces into hardware-supported drawing commands. The execution result of the drawing command is often directly reflected on the display screen. Therefore, it is very important to ensure the correctness of the execution result of the drawing command. In order to improve the versatility and computational performance of graphics drawing hardware, a Computer Shader (CS) is generally added to perform massively parallel computing, and the general computing command (dispatch command) is a generic command configured to trigger the computer shader. The results of the general computing command can be used as input to the drawing command in some scenarios, and will ultimately be indirectly reflected in the drawing results. Therefore, the correctness of the results of the general computing commands is also important. When users develop applications (APPs), some resource initialize APIs or resource copy APIs are usually used to prepare the required resources for the subsequent drawing/general computing commands. In order to ensure the real-time reliability of the resource data, the software driver layer converts these APIs into resource initialization/copy commands that can be executed by the hardware, and then synchronize them with the subsequent drawing commands and general computing commands by inserting synchronization commands between the data. As 2D commands that prepare the corresponding resources for the subsequent drawing and general computing commands, the execution results of these resource initialization/copy commands are also the focus of the present solution.

In step S304, for each of the command data, on a condition that the command data matches the present upper-level task, the command data is input into the process verification model to simulate the execution to obtain the command feature value of the command data.

Exemplarily, for each command data, on a condition that the command data matches the present upper-level task, the server 104 input the command data into the process verification model to simulate the execution to obtain the command feature value of the command data using the command stream parser. Further, the command stream parser includes a command counter. The command counter is configured to record the number of occurrences of the task at each level, and calculate the address where the feature value is to be stored based on the counting result when the feature value needs to be recorded to the storage module. The following is an example of a drawing task marked with “★” in FIG. 3. Assuming that the storage space of each feature value of ““draw/general computing”-level task in the second layer” is N byte(s), the software driver layer assigns a starting address “Start_Addr” for the feature value of this level. The drawing task marked with “★” is the third drawing task in the second submitted submission-level task (also called DMA task), and assuming that there are 4 drawing tasks in the first submitted DMA as shown in the figure, then the corresponding command counter will be updated to 7 according to “4+3=7” after completing the drawing task marked with “★”, and the corresponding storage address of its feature value is as follows:

$$Address = Start\_Addr + ( 7 - 1 ) * N$$

Each layer of tasks corresponds to one command counter. A DMA (submission-level task) task counter is configured to record the present number of DMA task. A drawing/general computing task counter performs a cumulative count between DMAs to record the present number of drawing/general computing task. A resource initialization/copy task counter performs a cumulative count between DMA and drawing/general computing tasks to record the present number of resource initialization/copy task.

In another embodiment, the command stream parser determines whether the present command data indicates the end of the execution of the upper-level task before calculating the number of the command feature value for the present command.

In step S306, the command feature values are continuously accumulated on a condition that the present command data does not indicate the end of the execution of the upper-level task.

Exemplarily, the feature value calculator can return the accumulated feature value upon receiving a read signal from the command stream parser. It should be noted that the calculation of the feature value is a cumulative process, therefore, the calculated feature value needs to be used as an input to calculate a new feature value together with the next input data.

In step S308, the command feature value is accumulated to obtain the task reference feature value on a condition that the present command data indicates the end of the execution of the upper-level task.

Exemplarily, on a condition that the present command data indicates the end of the execution of the upper-level task, the server 104 can accumulate the command feature value for the last time to obtain the task reference feature value. The server 104 can also reset the accumulated task feature value in the feature value calculator to zero after obtaining the task reference feature value.

Further, upon receiving a reset signal from the command stream parser, the feature value calculator can reset all feature value information to zero. By resetting, erroneous transmissions between tasks can be avoided.

Exemplarily, the server 104 can obtain the task type of the present upper-level task after inputting the task data of the present upper-level task into the process verification model to simulate the execution to obtain the task reference feature value, obtain a historical cumulative data corresponding to the present upper-level task according to the task type, calculate the present cumulative data based on the historical cumulative data, calculate a storage address information based on the present cumulative data, and store the present cumulative data based on the storage address information.

In an exemplary embodiment, as shown in FIG. 5, the task includes at least one command, and the task data includes command data, step S304 includes step S402 to step S406.

In step S402, the command data is input into the process verification model to obtain the data feature of the command data.

Exemplarily, the data feature can be obtained directly when obtaining the command data. Alternatively, the data feature can be identified after the command data is obtained.

In step S404, a feature value calculation method is selected based on the data feature.

Given that the features of different command data are not the same (for example, color values, depth values, template values, and resource initialization, copy results have strict requirements on the order of data, while the UAV does not require the order of the data; another example is that the template data must be 8 bits, while the depth data can be 16 bits, 24 bits, or 32 bits), the server 104 can design different feature value calculation algorithms for different data features according to their respective features and select the appropriate size of feature values (32 bits, 64 bits, 128 bits, etc.) for them.

In step S406, the command feature value of the command data is calculated by using the selected feature value calculation method.

Exemplarily, in the process of accumulating the command feature values in the above steps S306 and S308, the server 104 can determine the accumulative calculation method based on the feature value calculation method, and then the server 104 can accumulate the command feature values using the accumulative calculation method.

In another exemplary embodiment, at first, the server 104 sequentially obtains command data of a plurality of tasks in a target process, and the command stream parser parses the command data to determine whether the process number of the present command conforms to the target process, and if so, the command stream parser determines the task level of the present command, where the task level of the present command is one of the submission-level task, the “draw/general computing”-level task, and the resource initialization/copy-level task.

For the command data of the submission-level task, the feature value calculator calculates the feature value of the command data according to the key drawing and calculation data, obtains the data features of the command data, selects a feature value calculation method according to the data features, and calculates the command feature value of the command data by using the selected feature value calculation method. The command stream parser determines an accumulative calculation method according to the feature value calculation method, and accumulates the command feature values by using the accumulative calculation method. When the command stream parser determines that the present command is the last command indicating the end of the present task, it sends a read signal to the feature value calculator, so that the calculated task reference feature value is recorded and stored. The command stream parser obtains a task type of the present upper-level task, obtains the historical accumulative data corresponding to the present upper-level task according to the task type, calculates the present accumulative data according to the historical accumulative data, calculates the storage address information according to the present accumulative data, and stores the task reference feature value according to the storage address information. The historical accumulative data refers to the total number of occurrences of the current type of task. Then, the command stream parser compares the task reference feature value with the hardware execution feature value of the target process, and sends a reset signal to the feature value calculator after the end, so as to empty the current accumulated data. On a condition that the present task feature is inconsistent with the hardware execution feature value, the task number is recorded.

Subsequently, the server 104 can select a drawing/general computing task that needs to be simulated for execution according to the task number of the submission-level task, simulate the execution based on the task data, and record the task number corresponding to the present abnormal “draw/general computing”-level task by using the above steps. Finally, the server 104 can select the resource initialization/copy task that needs to be simulated according to the task number of the “draw/general computing”-level task, so as to locate the execution exception of the target process.

It should be understood that although the steps in the flowchart to which the embodiments as described above relate are shown sequentially as indicated by the arrows, these steps are not necessarily performed sequentially as indicated by the arrows. Unless expressly stated in this article, there is no strict order limit to the execution of these steps, and these steps can be performed in other order. Moreover, at least a portion of the steps in the flowchart to which the embodiments as described above relate may include a plurality of steps or stages, which are not necessarily performed at the same time, but may be performed at different times, and the execution sequence of these steps or stages is not necessarily performed sequentially, but may be performed alternately or alternately with other steps or at least a portion of steps or stages among other steps.

Based on the same inventive concept, the embodiment of the present application also provides a device for locating process execution exception for implementing the method for locating a process execution exception as described above. The solution for solving the problem provided by the device is similar to the solution described above, so the features in one or more embodiments of the device for locating a process execution exception provided below can be referred to in the above-mentioned features of the method for locating a process execution exception, and will not be repeated here.

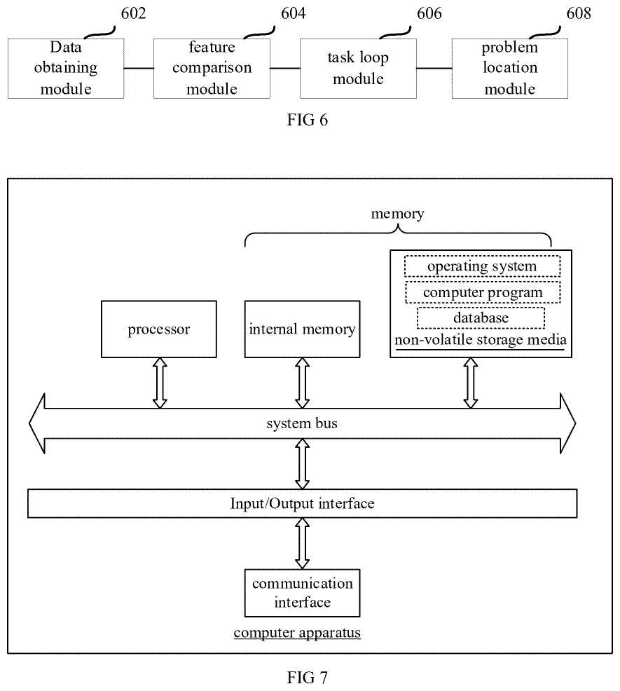

In an exemplary embodiment, as shown in FIG. 6, the present disclosure provides a device for locating a process execution exception, which is configured to locate execution issues in a target process. The target process includes a plurality of tasks, and the plurality of tasks are divided into a plurality of levels. Each upper-level task includes at least one lower-level task. The device includes: a data obtaining module 602, a feature comparison module 604, a task loop module 606, and a problem location module 608.

The data obtaining module 602 is configured to obtain task data of the plurality of tasks, and input the task data of a present upper-level task into a process verification model to simulate an execution to obtain a task reference feature value. The process verification model is configured to calculate a correct execution result of the process.

The feature comparison module 604 is configured to compare the task reference feature value with the execution feature value corresponding to the present upper-level task in the target process, and record an upper-level task number corresponding to the present upper-level task when the task reference feature value is inconsistent with the execution feature value.

The task loop module 606 is configured to select, when the lower-level task corresponding to the upper-level task is not the bottom-level task, the lower-level task that needs to be simulated according to the upper-level task number, take the lower-level task as a new upper-level task, and repeat the steps of simulation. The bottom-level task is not the lower-level task.

The problem location module 608 is configured to select, when the lower-level task corresponding to the upper-level task is the bottom-level task, the bottom-level task that needs to be simulated according to the upper-level task number, and input the task data of the bottom-level task into the process verification model to locate the issue that causes the execution exception in the target process.

In an embodiment, the task includes at least one command, and the task data includes command data. The data obtaining module 602 includes:
a data obtaining unit configured to obtaining command data of a plurality of commands;
a simulation execution unit configured to, for each of the command data, input the command data into the process verification model to simulate the execution to obtain a command feature value of the command data when the command data matches the present upper-level task; and
a data accumulation unit configured to accumulate the command feature value when the present command data does not indicate the end of the execution of the upper-level task, and accumulate the command feature value to obtain the task reference feature value when the present command data indicates the end of the execution of the upper-level task.

In an embodiment, the data acquisition module 602 also includes:
a data reset unit configured to reset the accumulated task feature value to zero.

In an embodiment, the simulation execution unit is configured to input the command data into the process verification model to obtain the data feature of the command data; select a feature value calculation method based on the data feature; and calculate the command feature value of the command data by the feature value calculation method.

In an embodiment, the data accumulation unit is configured to determine a cumulative calculation method according to the feature value calculation method; and accumulate the command feature value by the cumulative calculation method.

In an embodiment, the device also includes:
a type determination module configured to obtain a task type of the present upper-level task;
a count module configured to obtain a historical cumulative data corresponding to the present upper-level task according to the task type, and calculate the present cumulative data based on the historical cumulative data; and
an address determination module configured to calculate a storage address information based on the present cumulative data, and store the present cumulative data based on the storage address information.

Each module in the device for locating a process execution exception can be implemented in whole or in part by software, hardware, and a combination thereof. The modules can be embedded in or independent of the processor in the computer equipment in the form of hardware, or stored in the memory in the computer equipment in the form of software, so that the processor can call and execute the operations corresponding to the modules.

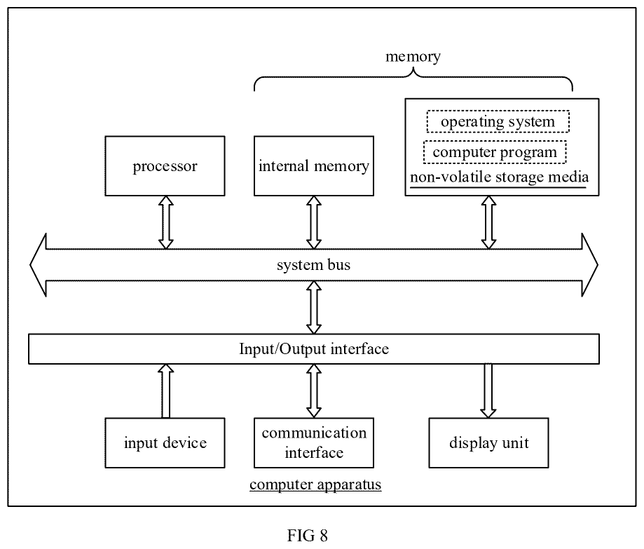

In an exemplary embodiment, the present disclosure provides a computer apparatus, the computer apparatus can be a server, and its internal structure can be shown in FIG. 7. The computer apparatus includes a processor, a memory, an Input/Output (I/O) interface and a communication interface. The processor, the memory and the input/output interface are connected through a system bus, and the communication interface is connected to the system bus through the Input/Output interface. The processor of the computer apparatus is used to provide computing and control capabilities. The memory of the computer apparatus includes a non-transitory storage medium and an internal memory. The non-transitory storage medium stores an operating system, a computer program, and a database. The internal memory provides an operation environment for the operating system and computer programs in the non-transitory storage medium. The database of the computer apparatus is configured for storing data such as task data, command data, etc. The Input/Output interface of the computer apparatus is configured for exchanging information between the processor and the external device. The communication interface of the computer apparatus is configured for communicating with an external terminal through a network connection. The computer program is executed by the processor to implement the method for locating a process execution exception.

In an exemplary embodiment, the present disclosure provides a computer apparatus. The computer apparatus can be a terminal, and its internal structure can be shown in FIG. 8. The computer apparatus includes a processor, a memory, an Input/Output (I/O) interface, a communication interface, a display unit, and an input device. The processor, the memory and the I/O interface are connected through a system bus. The communication interface, the display unit and the input device are connected to the system bus through the I/O interface. The processor of the computer apparatus is configured to provide computing and control capabilities. The memory of the computer apparatus includes a non-transitory storage medium and an internal memory. The non-transitory storage medium stores an operating system and a computer program. The internal memory provides an operation environment for the operating system and computer programs in the non-transitory storage medium. The I/O interface of the computer apparatus is configured for exchanging information between the processor and the external device. The communication interface of the computer apparatus is configured for communicating with external terminals via a wired or wireless manner, and the wireless manner can be WIFI, mobile cellular network, NFC (near field communication) or other technologies. The computer program is executed by the processor to implement the method for locating a process execution exception.

Those skilled in the art will understand that the structure shown in FIG. 7 and FIG. 8 is only a block diagram of a partial structure related to the solution provided in the present disclosure and does not constitute a limitation on the computer apparatus to which the solution of the present disclosure is applied, and the specific computer apparatus may include more or fewer components than shown in the figures, or combine certain components, or have different component arrangements.

In an exemplary embodiment, the present disclosure provides a computer apparatus. The computer apparatus includes a processor, and a memory having a computer program stored therein. When the computer program is executed by the processor, the processor is caused to perform the following steps: obtaining task data of tasks, and inputting the task data of a present upper-level task into a process verification model to simulate the execution to obtain a task reference feature value, the process verification model being configured to calculate a correct execution result of the process; comparing the task reference feature value with an execution feature value corresponding to the present upper-level task in the target process, and recording the upper-level task number corresponding to the present upper-level task when the task reference feature value is inconsistent with the execution feature value; selecting, when the lower-level task corresponding to the upper-level task is not the bottom-level task, the lower-level task that needs to be simulated according to the upper-level task, taking the lower-level task as a new upper-level task, and repeating the steps of the simulation, where the bottom-level task is not the lower-level task; and selecting, when the lower-level task corresponding to the upper-level task is the bottom-level task, the bottom-level task that needs to be simulated according to the upper-level task number, and inputting the task data of the bottom-level task into the process verification model to locate the execution exception in the target process.

In an embodiment, the processor also implements the following steps when executing the computer program: obtaining command data of a plurality of commands; for each of the command data, when the command data matches the present upper-level task, inputting the command data into the process verification model to simulate the execution to obtain a command feature value of the command data; accumulating the command feature value when the present command data does not indicate the end of the execution of the upper-level task; and accumulating the command feature value to obtain the task reference feature value when the present command data indicates the end of the execution of the upper-level task.

In an embodiment, the processor also implements the following steps when executing the computer program: resetting the accumulated task feature value to zero.

In an embodiment, the processor also implements the following steps when executing the computer program: inputting the command data into the process verification model to obtain a data feature of the command data; selecting a feature value calculation method based on the data feature; and calculating the command feature value of the command data by the feature value calculation method.

In an embodiment, the processor also implements the following steps when executing the computer program: determining a cumulative calculation method according to the feature value calculation method; and accumulating the command feature value by using the cumulative calculation method.

In an embodiment, the processor also implements the following steps when executing the computer program: obtaining a task type of the present upper-level task; obtaining a historical cumulative data corresponding to the present upper-level task according to the task type, calculating present cumulative data based on the historical cumulative data; calculating storage address information based on the present cumulative data, and storing the present cumulative data based on the storage address information.

In an exemplary embodiment, the present disclosure provides a computer-readable storage medium, the computer-readable storage medium has computer program stored therein. The computer program, when executed by a processor, causes the processor to implement the following steps: obtaining task data of tasks, and inputting the task data of a present upper-level task into a process verification model to simulate an execution to obtain a task reference feature value, the process verification model being configured to calculate a correct execution result of the process; comparing the task reference feature value with an execution feature value corresponding to the present upper-level task in the target process, and recording the upper-level task number corresponding to the present upper-level task when the task reference feature value is inconsistent with the execution feature value; selecting, when a lower-level task corresponding to the upper-level task is not the bottom-level task, the lower-level task that needs to be simulated according to the upper-level task number, taking the lower-level task as a new upper-level task, and repeating the steps of the simulation, where the bottom-level task is not the lower-level task; and selecting, when the lower-level task corresponding to the upper-level task is the bottom-level task, the bottom-level task that needs to be simulated according to the upper-level task number, and inputting the task data of the bottom-level task into the process verification model to locate the execution exception in the target process.

In an embodiment, the computer program, when executed by the processor, also cause the processor to implement the following steps: obtaining command data of a plurality of commands; for each of the command data, when the command data matches the present upper-level task, inputting the command data into the process verification model to simulate the execution to obtain a command feature value of the command data; accumulating the command feature value when the present command data does not indicate the end of the execution of the upper-level task; and accumulating the command feature value to obtain the task reference feature value when the present command data indicates the end of the execution of the upper-level task.

In an embodiment, the computer program, when executed by the processor, also cause the processor to implement the following steps: resetting the accumulated task feature value to zero.

In an embodiment, the computer program, when executed by the processor, also causes the processor to implement the following steps: inputting the command data into the process verification model to obtain a data feature of the command data; selecting a feature value calculation method based on the data feature; and calculating the command feature value of the command data by using the feature value calculation method.

In an embodiment, the computer program, when executed by the processor, also cause the processor to implement the following steps: determining a cumulative calculation method according to the feature value calculation method; and accumulating the command feature value by using the cumulative calculation method.

In an embodiment, the computer program, when executed by the processor, also causes the processor to implement the following steps: obtaining a task type of the present upper-level task; obtaining a historical cumulative data corresponding to the present upper-level task according to the task type; calculating present cumulative data based on the historical cumulative data; calculating storage address information based on the present cumulative data, and storing the present cumulative data based on the storage address information.

In an exemplary embodiment, the present disclosure provides a computer program product, the computer program product includes computer programs, the computer program realizes the following steps when it is executed by the processor: getting task data of the task, and inputting the task data of the present upper-level task into the process verification model to simulate the execution to obtain the task reference feature value, in which the process verification model is configured to calculate the correct execution result of the process; comparing the task reference feature value with the execution feature value corresponding to the present upper-level task in the target process, and recording the upper-level task sequence number corresponding to the present upper-level task when the task reference feature value is inconsistent with the execution feature value; selecting, when the lower-level task corresponding to the upper-level task is not the underlying task, the lower-level task that needs to be simulated according to the upper-level task sequence number, and taking the lower-level task as the new upper-level task, repeating the steps of executing the simulation; the underlying task is not the lower-level task; and selecting, when the lower-level task corresponding to the upper-level task is the underlying task, the underlying task that needs to be simulated according to the upper-level task sequence number, and inputting the task data of the underlying task into the process verification model to locate exception execution issues in the target process.

In an embodiment, the computer program, when executed by the processor, also implements the following steps: obtaining command data of multiple commands; for each of the command data, when the command data matches the present upper-level task, inputting the command data into the process verification model to simulate the execution to obtain the command feature value of the command data; accumulating the command feature value when the present command data does not indicate the end of the upper-level task execution; and accumulating the command feature value to obtain the task reference feature value when the present command data indicates the end of the upper-level task execution.

In an embodiment, the computer program, when executed by the processor, also implements the following steps: resetting the accumulated task feature value to zero.

In an embodiment, the computer program, when executed by the processor, also implements the following steps: inputting the command data into the process verification model to obtain the data characteristic of the command data; selecting a feature value calculation method based on the data characteristic; and calculating the command feature value of the command data by the feature value calculation method.

In an embodiment, the computer program, when executed by the processor, also implements the following steps: determining a cumulative calculation method according to the feature value calculation method; and accumulating the command feature value by the cumulative calculation method.

In an embodiment, the computer program, when executed by the processor, also implements the following steps: extracting the task type of the present upper-level task; getting the historical cumulative data corresponding to the present upper-level task according to the task type, and calculating the present cumulative data based on the historical cumulative data; and calculating the storage address information based on the present cumulative data, and storing the present cumulative data based on the storage address information.

Those of ordinary skill in the art will appreciate that all or part of the flow in the above embodiments can be implemented by instructing the relevant hardware through a computer program, which can be stored in a non-volatile computer-readable storage medium, and that the computer program, when executed, can include the flow as in the above embodiments. Wherein, any reference to a memory, database, or other medium used in the embodiments provided herein may include at least one of a non-volatile memory and a volatile memory. The non-volatile memory may include Read-Only Memory (ROM), magnetic tape, floppy disk, flash memory, optical memory, high-density embedded non-volatile memory, resistive variable memory (ReRAM), Magneto resistive Random Access Memory (MRAM), Ferroelectric Random Access Memory (FRAM), Phase Change Memory (PCM), graphene memory, and the like. The volatile memory may include a Random Access Memory (RAM) or an external cache memory or the like. By way of illustration and not limitation, RAM may be in various forms, such as Static Random Access Memory (SRAM) or Dynamic Random Access Memory (DRAM), and the like. The database referred to in the embodiments provided by the present application may include at least one of a relational database and a non-relational database. Non-relational databases may include, but are not limited to, blockchain-based distributed databases, and the like. The processors involved in the embodiments provided in the present application may be general purpose processors, processors, graphics processors, digital processors, programmable logic devices, quantum computing-based data processing logic devices, and the like, without limitation thereto.

The technical features in the above embodiments can be combined arbitrarily. For concise description, not all possible combinations of the technical features in the above embodiments are described. However, all the combinations of the technical features are to be considered as falling within the scope described in this specification provided that they do not conflict with each other.

The above-mentioned embodiments only describe several implementations of the present disclosure, and their description is specific and detailed, but should not be understood as a limitation on the patent scope of the present disclosure. It should be pointed out that for a person of ordinary skill in the art may further make variations and improvements without departing from the conception of the present disclosure, and these all fall within the protection scope of the present disclosure. Therefore, the protection scope of the present disclosure should be subject to the appended claims.

What is claimed is:

1. A method for locating a process execution exception, the method being applied to an electronic device and configured to locate exception execution issues in a target process running on the electronic device, the electronic device comprising a command stream parser, the target process comprising a plurality of tasks, and the plurality of tasks are divided into a plurality of levels, each upper-level task comprising at least one lower-level task,
wherein the method comprises:
obtaining, by the command stream parser, task data of the plurality of tasks of the target process, and inputting the task data of a present upper-level task into a process verification model to simulate an execution to obtain a task reference feature value, wherein the process verification model is configured to calculate a correct execution result of the target process;
comparing, by the command stream parser, the task reference feature value with an execution feature value corresponding to the present upper-level task in the target process, and recording an upper-level task number corresponding to the present upper-level task when the task reference feature value is inconsistent with the execution feature value;
on a condition that the lower-level task corresponding to the upper-level task is not a bottom-level task, selecting, by the command stream parser, the lower-level task that needs to be simulated according to the task number of the upper-level task, and taking the lower-level task as a new upper-level task, and repeating the step of simulation; wherein the bottom-level task is not the lower-level task; and
on a condition that the lower-level task corresponding to the upper-level task is the bottom-level task, selecting, by the command stream parser, the bottom-level task that needs to be simulated according to the task number of the upper-level task, and inputting the task data of the bottom-level task into the process verification model to locate exception execution issues in the target process.

2. The method of claim 1, wherein the task comprises at least one command, and the task data comprises command data; obtaining the task data of the plurality of tasks, and inputting the task data of the present upper-level task into the process verification model to simulate the execution to obtain the task reference feature value comprises:
obtaining command data of multiple commands;
for each of the command data, on a condition that the command data matches the present upper-level task, inputting the command data into the process verification model to simulate the execution to obtain the command feature value of the command data;
accumulating the command feature value continuously on a condition that the present command data does not indicate an end of an execution of the upper-level task; and
accumulating the command feature value to obtain the task reference feature value on a condition that the present command data indicates the end of the execution of the upper-level task.

3. The method of claim 2, wherein after accumulating the command feature value to obtain the task reference feature value, the method further comprises:
resetting the accumulated task feature value to zero.

4. The method of claim 2, wherein inputting the command data into the process verification model to simulate the execution to obtain the command feature value of the command data comprises:
inputting the command data into the process verification model to obtain the data feature of the command data;
selecting a feature value calculation method based on the data feature; and
calculating the command feature value of the command data by using the selected feature value calculation method.

5. The method of claim 4, wherein accumulating the command feature value comprises:
determining an accumulative calculation method according to the feature value calculation method; and
accumulating the command feature value by the using accumulative calculation method.

6. The method of claim 1, wherein after inputting the task data of the present upper-level task into the process verification model to simulate the execution to obtain the task reference feature value, the method further comprises:
obtaining the task type of the present upper-level task;
obtaining a historical cumulative data corresponding to the present upper-level task according to the task type, and calculating a present cumulative data based on the historical cumulative data; and
calculating a storage address information based on the present cumulative data, and storing the present cumulative data based on the storage address information.

7. A device for locating a process execution exception, the device being configured to locate exception execution issues in a target process, the target process comprises a plurality of tasks, and the plurality of tasks are divided into multiple levels, each upper-level task comprising at least one lower-level task; wherein the device comprises:
a data obtaining module configured to obtain task data of the plurality of tasks, and input the task data of a present upper-level task into a process verification model to simulate an execution to obtain a task reference feature value, wherein the process verification model is configured to calculate a correct execution result of the target process;
a feature comparison module configured to compare the task reference feature value with an execution feature value corresponding to the present upper-level task in the target process, and record an upper-level task number corresponding to the present upper-level task when the task reference feature value is inconsistent with the execution feature value;
a task loop module configured to select, on a condition that the lower-level task corresponding to the upper-level task is not a bottom-level task, the lower-level task that needs to be simulated according to the task number of the upper-level task, take the lower-level task as a new upper-level task, and repeat the step of simulation; wherein the bottom-level task is not the lower-level task; and
a problem location module configured to select, on a condition that the lower-level task corresponding to the upper-level task is the bottom-level task, the bottom-level task that needs to be simulated according to the task number of the upper-level task, and input the task data of the bottom-level task into the process verification model to locate exception execution issues in the target process.

8. A computer apparatus comprises a processor, and a memory having a computer program stored therein, wherein when the computer program is executed by the processor, the processor is caused to implement the following steps:
obtaining task data of the plurality of tasks of a target process, and inputting the task data of a present upper-level task into a process verification model to simulate an execution to obtain a task reference feature value, wherein the process verification model is configured to calculate a correct execution result of the target process;
comparing the task reference feature value with an execution feature value corresponding to the present upper-level task in the target process, and recording an upper-level task number corresponding to the present upper-level task when the task reference feature value is inconsistent with the execution feature value;
selecting, on a condition that the lower-level task corresponding to the upper-level task is not a bottom-level task, the lower-level task that needs to be simulated according to the task number of the upper-level task, and taking the lower-level task as a new upper-level task, and repeating the step of simulation; wherein the bottom-level task is not the lower-level task; and
selecting, on a condition that the lower-level task corresponding to the upper-level task is the bottom-level task, the bottom-level task that needs to be simulated according to the task number of the upper-level task, and inputting the task data of the bottom-level task into the process verification model to locate exception execution issues in the target process.

9. The computer apparatus according to claim 8, wherein the task comprises at least one command, and the task data comprises command data; obtaining the task data of the plurality of tasks, and inputting the task data of the present upper-level task into the process verification model to simulate the execution to obtain the task reference feature value comprises:
obtaining command data of multiple commands;
for each of the command data, on a condition that the command data matches the present upper-level task, inputting the command data into the process verification model to simulate the execution to obtain the command feature value of the command data;
accumulating the command feature value continuously on a condition that the present command data does not indicate an end of an execution of the upper-level task; and
accumulating the command feature value to obtain the task reference feature value on a condition that the present command data indicates the end of the execution of the upper-level task.

10. The computer apparatus according to claim 9, wherein when the computer program is executed by the processor, the processor is caused to implement the following steps:
resetting the accumulated task feature value to zero after accumulating the command feature value to obtain the task reference feature value.

11. The computer apparatus according to claim 9, wherein inputting the command data into the process verification model to simulate the execution to obtain the command feature value of the command data comprises:
inputting the command data into the process verification model to obtain the data feature of the command data;
selecting a feature value calculation method based on the data feature; and
calculating the command feature value of the command data by using the selected feature value calculation method.

12. The computer apparatus according to claim 9, wherein inputting the command data into the process verification model to simulate the execution to obtain the command feature value of the command data comprises:
inputting the command data into the process verification model to obtain the data feature of the command data;
selecting a feature value calculation method based on the data feature; and
calculating the command feature value of the command data by using the selected feature value calculation method.

13. The computer apparatus according to claim 12, wherein accumulating the command feature value comprises:
determining an accumulative calculation method according to the feature value calculation method; and
accumulating the command feature value by the using accumulative calculation method.

14. The computer apparatus according to claim 8, wherein when the computer program is executed by the processor, the processor is further caused to implement the following steps after inputting the task data of the present upper-level task into the process verification model to simulate the execution to obtain the task reference feature value:
obtaining the task type of the present upper-level task;
obtaining a historical cumulative data corresponding to the present upper-level task according to the task type, and calculating a present cumulative data based on the historical cumulative data; and
calculating a storage address information based on the present cumulative data, and storing the present cumulative data based on the storage address information.

15. A computer-readable storage medium having computer-executable instructions stored therein, wherein the computer-executable instructions are configured to execute the method of claim 1.

16. A computer program product comprises computer program, wherein the computer-executable instructions are configured to execute the method of claim 1.
